(19) United States
(12) Patent Application Publication
(10) Pub. No.: US 2014/0186609 A1
(43) Pub. Date: Jul. 3, 2014

(54) FIBER-AND-PLASTIC COMPOSITE AND METHOD FOR MAKING SAME

(71) Applicants: FIH (Hong Kong) Limited, Kowloon (HK); SHENZHEN FUTAIHONG PRECISION INDUSTRY CO., LTD., Shenzhen (CN)

(72) Inventors: YAO-YAO QIN, Shenzhen (CN); SHU-XIANG ZHOU, Shenzhen (CN); QIU-JIANG XU, Shenzhen (CN)

(21) Appl. No.: 13/924,709

(22) Filed: Jun. 24, 2013

(30) Foreign Application Priority Data
Dec. 29, 2012 (CN) 2012105883810

(51) Int. Cl. B32B 27/12; B29C 45/14

(52) U.S. Cl. CPC B32B 27/12; B29C 45/14008
USPC 428/221; 264/257; 264/483

(57) ABSTRACT

A fiber-and-plastic composite includes a fiber composite, a plastic part, and a silane coupling agent layer and an adhesive layer formed between the fiber composite and the plastic parts. The silane coupling agent layer directly bonds with the fiber composite. The adhesive layer directly bonds with the plastic parts. The silane coupling agent layer comprises hydrolytic silane coupling agent. The adhesive layer includes one-component polyurethane.

### BACKGROUND

1. Technical Field

The present disclosure relates to composites, especially to a fiber-and-plastic composite and a method for making the composite.

2. Description of the Related Art

Fiber prepreg cloth consists of fiber and uncured resin, with the fiber soaking in the uncured resin. The fiber prepreg cloths possess the advantages of being light-weight, high strength, and have high resistance to chemical corrosion, and are widely used to fabricate fiber composites using the heating-pressing method. The heating-pressing method includes the following steps: trimming the fiber prepreg cloth to a desired shape; positioning the trimmed fiber prepreg cloth in a mold; pressing and heating the cloth in the mold; and cooling the fiber composite in the mold.

The fiber composite can only have two-dimensional structure, and cannot integrally form with functional parts (such as buckle, stud, for example) during the molding process. Therefore, the functional parts need to be coupled to the fiber composite with adhesive. However, the bond between the fiber composite and the functional parts is not strong enough due to the limitations of the adhesive.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the disclosure. Moreover, in the drawings like reference numerals designate corresponding parts throughout the several views. Wherever possible, the same reference numbers are used throughout the drawings to refer to the same or like elements of an embodiment.

FIG. 1 is a cross-sectional view of an example of a fiber-and-plastic composite.

FIG. 2 is a cross-sectional view of an example of an injection mold for making the fiber-and-plastic composite.

### DETAILED DESCRIPTION

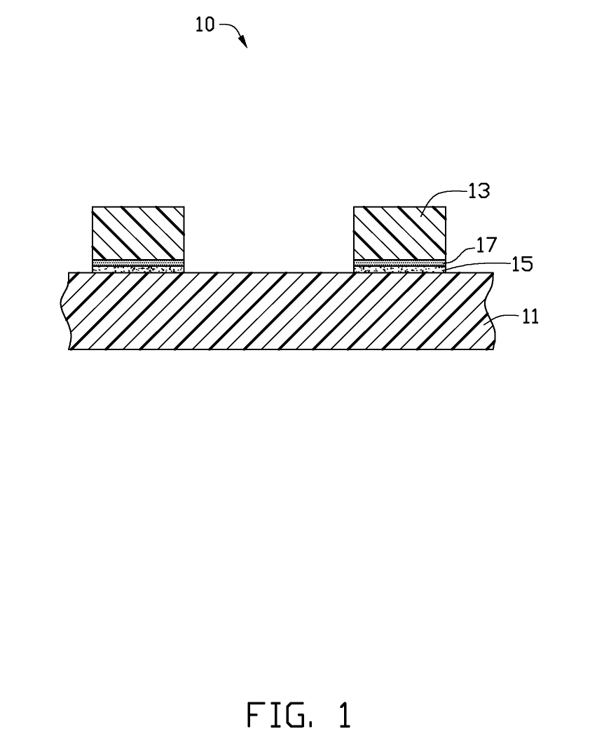

FIG. 1 shows a fiber-and-plastic composite 10 which includes a fiber composite 11 and at least one plastic part 13 formed on the fiber composite 11. The fiber composite 11 contains fiber and epoxy resin. The fiber can be carbon fiber, glass fiber, or polyamide fiber. The plastic part 13 is made of conventional thermoplastic resin. The plastic parts 13 are molded on the fiber composite 11. In the exemplary embodiment, there are two plastic parts 13.

The fiber-and-plastic composite 10 further includes a silane coupling agent layer 15 and an adhesive layer 17 formed between the fiber composite 11 and the plastic parts 13. The silane coupling agent layer 15 directly bonds with the fiber composite 11. The adhesive layer 17 directly bonds with the plastic parts 13. The silane coupling agent layer 15 contains hydrolytic silane coupling agent. The adhesive layer 17 mainly contains one-component polyurethane.

The adhesive layer 17 may further contain an emulsifier and a pH regulating agent.

The drawing force between the fiber composite 11 and the plastic parts 13 are 3.28 Mpa. While the conventional fiber composite which does not include silane coupling agent layer has a drawing force between the fiber composite and the plastic parts of 2.64 Mpa. This shows that the fiber composite 11 and the plastic parts 13 of the fiber-and-plastic composite 10 bonds firmer than the conventional fiber composite without the silane coupling agent.

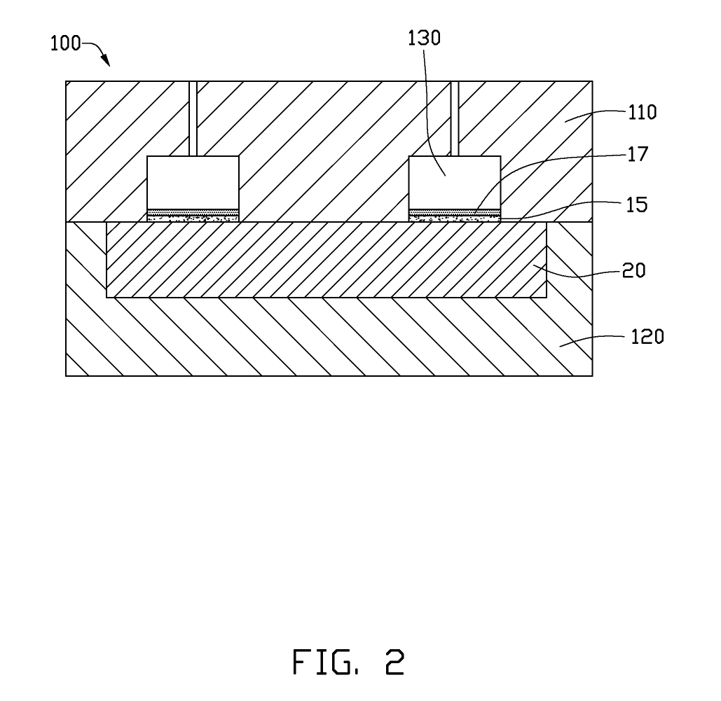

FIG. 2 shows an exemplary method for making the fiber-and-plastic composite 10 may includes the following steps.

A fiber prepreg cloth 20 containing fiber and uncured epoxy resin is provided. The fiber can be carbon fiber, glass fiber, or polyamide fiber.

The fiber prepreg cloth 20 is corona discharged by high-frequency alternating current. The high-frequency alternating current makes gas around the fiber prepreg cloth 20 to generate low-temperature plasma. The low-temperature plasma actuates the epoxy resin molecules on the surface of the fiber prepreg cloth 20 to rearrange and generate more polar positions. As a result, the property of the fiber prepreg cloth 20 for adhering is effectively improved. The voltage of the high-frequency alternating current is about 5000 V/m² to about 15000 V/m², and the frequency of the high-frequency alternating current is about 15 kHZ to 24 kHZ.

A solution containing silane coupling agent is coated on the surface of the fiber prepreg cloth 20 and is dried to form a silane coupling agent layer 15. The drying of the solution may be carried out at a temperature of about 80° C. to about 120° C. for about 15 min to about 60 min. The solution containing silane coupling agent is made by the following steps: mixing the silane coupling agent and an organic solvent to obtain a mixture, the weight ratio of the silane coupling agent to the organic solvent is 3˜5:95˜97; adding deionized water to the mixture, the weight of the deionized water is about 3%˜5% of the weight of the silane coupling agent. The organic solvent can be but not limited to alcohol. Hydroxyl groups of the epoxy resin and the hydroxyl groups generating from the hydrolytic silane coupling agent dehydrate and chemically bond together, and the other hydroxyl groups of the hydrolytic silane coupling agent distributes on the surface of the fiber prepreg cloth 20. Thus, the activity of the fiber prepreg cloth 20 is improved.

An adhesive is coated on the surface of the silane coupling agent 15 to form an adhesive layer 17. The adhesive mainly contains one-component polyurethane. The adhesive may further contain an emulsifier, a diluent, and a pH regulating agent. The adhesive generally contains solids in an amount of 40% to 60% by weight.

Amino groups of the adhesive and the hydroxyl groups generating from the hydrolytic silane coupling agent dehydrate and chemically bond together. Thus, the silane coupling agent layer 15 and the adhesive layer 17 can bond together firmly.

The one-component polyurethane of the adhesive contains isocyanicacid end groups (—NCO), which can penetrate the silane coupling agent layer 15 and react with hydroxyl groups of the epoxy resin of the fiber prepreg cloth 20.

As shown in FIG. 2, an injection mold 100 is provided. The injection mold 100 includes an upper mold 110 and a lower mold 120. The upper mold 110 and the lower mold 120 coorporately form a molding cavity 130. The fiber prepreg cloth 20 having the silane coupling agent layer 15 and the adhesive layer 17 is positioned in the lower mold 120. The upper mold 110 attaches to the lower mold 120, and the fiber prepreg cloth 20 is heated and pressed in the molding cavity 130. At the same time, molten thermoplastic plastic material is injected in the molding cavity 130 to the surface of the adhesive layer 17 and forms to be plastic parts 13. Meanwhile the epoxy resin of the fiber prepreg cloth 20 cures and the prepreg cloth 20 forms a fiber composite 11. The plastic parts 13 may be buckles or studs.

It is to be understood that even though numerous characteristics and advantages of the present embodiments have been set forth in the foregoing description, together with details of assemblies and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A fiber-and-plastic composite, comprising:
a fiber composite;
a plastic part; and
a silane coupling agent layer and an adhesive layer formed between the fiber composite and the plastic part, the silane coupling agent layer directly bonding with the fiber composite, the adhesive layer directly bonding with the plastic part, the silane coupling agent layer comprising hydrolytic silane coupling agent, the adhesive layer comprising one-component polyurethane.

2. The fiber-and-plastic composite as claimed in claim 1, wherein the fiber composite comprises fiber and epoxy resin.

3. The fiber-and-plastic composite as claimed in claim 2, wherein the fiber is carbon fiber, glass fiber, or polyamide fiber.

4. The fiber-and-plastic composite as claimed in claim 1, wherein the adhesive layer further contains an emulsifier.

5. The fiber-and-plastic composite as claimed in claim 1, wherein the adhesive layer further contain a pH regulating agent.

6. The fiber-and-plastic composite as claimed in claim 1, wherein the plastic parts is made of thermoplastic resin.

7. A method for making a fiber-and-plastic composite, comprising:
providing a fiber prepreg cloth containing fiber and uncured epoxy resin;
coating a solution containing hydrolytic silane coupling agent on the surface of the fiber prepreg cloth and drying the solution to form a silane coupling agent layer;
coating an adhesive substantially comprising one-component polyurethane on the surface of the silane coupling agent layer to form an adhesive layer; and
positioning the fiber prepreg cloth in an injection mold, then heating and pressing fiber prepreg cloth to form a fiber composite, and injection molding a plastic part on the adhesive layer.

8. The method as claimed in claim 7, wherein further comprises corona discharging the fiber prepreg cloth by using high-frequency alternating current prior to forming the silane coupling agent layer.

9. The method as claimed in claim 8, wherein the voltage of the high-frequency alternating current is about 5000 V/m² to about 15000 V/m², and the working frequency of the high-frequency alternating current is about 15 kHZ to 24 kHZ.

10. The method as claimed in claim 7, wherein the solution containing hydrolytic silane coupling agent is made by the steps: mixing the silane coupling agent and an organic solvent together to obtain a mixture, the weight ratio of the silane coupling agent to the organic solvent is 3˜5:95˜97; adding deionized water to the mixture by drops, the weight of the deionized water is about 3%˜5% of the weight of the silane coupling agent.

11. The method as claimed in claim 10, wherein the organic solvent is alcohol.

12. The method as claimed in claim 7, wherein the drying of the solution is carried out at a temperature of about 80° C. to about 120° C. for about 15 min to about 60 min.

13. The method as claimed in claim 7, wherein the adhesive further comprises an emulsifier.

14. The method as claimed in claim 7, wherein the adhesive further comprises a diluent.

15. The method as claimed in claim 7, wherein the adhesive further comprises a pH regulating agent.

16. The method as claimed in claim 12, wherein the adhesive contains solids in an amount of 40% to 60% by weight.
